(19) United States
(12) Patent Application Publication
(10) Pub. No.: US 2026/0309377 A1
(43) Pub. Date: Oct. 8, 2026

(54) HEAT DISSIPATION CONTROL METHOD AND HEAT SINK SYSTEM

(71) Applicant: TILTA INC., Burbank, CA (US)

(72) Inventors: Yiling WANG, Shenzhen (CN); Wenping ZENG, Shenzhen (CN); Kefeng ZHOU, Shenzhen (CN)

(21) Appl. No.: 19/635,111

(22) Filed: Mar. 31, 2026

(30) Foreign Application Priority Data
Apr. 7, 2025 (CN) 202510430567.0

(51) Int. Cl. F25B 21/02

(52) U.S. Cl. CPC F25B 21/02; F25B 2321/0212; F25B 2321/0251

(57) ABSTRACT

Disclosed herein is a control method for a heat sink, which includes a refrigeration chip. The control method includes: calculating an operating power of the refrigeration chip through closed-loop control based on a predetermined first cold-end temperature threshold and a temperature deviation at the cold end of the refrigeration chip; calculating an operating power of the refrigeration chip through closed-loop control based on a predetermined first hot-end temperature threshold and a temperature deviation at the hot end of the refrigeration chip; and utilizing the operating power calculated based on the hot-end temperature of the heat sink as a threshold for the operating power calculated based on the cold-end temperature of the heat sink, thereby implementing dual closed-loop control on the refrigeration chip.

### CROSS-REFERENCE TO RELATED APPLICATIONS

The present application for patent claims priority to and the benefit of pending Chinese Application No. 202510430567.0, filed Apr. 7, 2025, and hereby expressly incorporated by reference herein as if fully set forth below in its entirety and for all applicable purposes.

### TECHNICAL FIELD

The present disclosure pertains to the technical field of heat dissipation, specifically to a heat dissipation control method and a heat sink system.

### INTRODUCTION

With technological advancements, electronic devices such as cameras and mobile phones have become ubiquitous in daily life. People use these devices to capture images and record videos. However, heat generation is a common issue during their operation, necessitating the use of heat sinks for heat dissipation. Due to the compact size of mobile phones, cameras, and other small electronic devices requiring heat dissipation, the available space for heat sinks is constrained, limiting the dimensions of the heat sink in design. Consequently, heat sinks currently available in the market struggle to provide rapid cooling for electronic devices.

A prevalent solution in the market involves using semiconductor refrigeration chips for heat dissipation. However, a challenge arises when high-efficiency cooling is required, as the semiconductor refrigeration chip demands significant power, leading to an increase in the temperature of the heat sink at the back of the refrigeration chip. If this heat is not promptly dissipated, the refrigeration efficiency significantly decreases.

### SUMMARY

Some aspects of the present application is to provide a control method for a heat sink and a heat sink system that enable rapid cooling of electronic devices, with the refrigeration temperature and heat dissipation temperature of the heat sink gradually reaching a balance point.

To address the aforementioned technical problem, the technical solution provided by the present disclosure includes:

A control method for a heat sink, which includes a refrigeration chip, including:

Calculating an operating power of the refrigeration chip through closed-loop control based on a predetermined first cold-end temperature threshold and a temperature deviation at the cold end of the refrigeration chip;

Calculating an operating power of the refrigeration chip through closed-loop control based on a predetermined first hot-end temperature threshold and a temperature deviation at the hot end of the refrigeration chip; and

Utilizing the operating power calculated based on the hot-end temperature of the heat sink as a threshold for the operating power calculated based on the cold-end temperature of the heat sink, thereby implementing dual closed-loop control on the refrigeration chip.

The present application also provides a heat sink system, including:

A refrigeration chip configured for refrigeration;

A first temperature detection module configured to detect the temperature at the cold end of the refrigeration chip;

A second temperature detection module configured to detect the temperature at the hot end of the refrigeration chip;

A fan driving module configured to drive a cooling fan;

A main control module configured to perform the heat dissipation control method on the refrigeration chip of the heat sink based on the temperatures detected at the cold and hot ends of the refrigeration chip.

Through dual closed-loop control, the control method described herein enables the refrigeration temperature of the heat sink and the heat dissipation temperature of the heat sink to gradually reach a balance point. On one hand, it facilitates rapid temperature reduction on the side of the heat sink that cools the electronic device, allowing for quick cooling of the electronic device. On the other hand, under high-power conditions, it effectively controls the temperature at the hot-end heat sink of the refrigeration chip, reducing the impact of the hot end on the refrigeration performance of the refrigeration chip, thereby ensuring rapid cooling of the electronic device by the heat sink.

### BRIEF DESCRIPTION OF THE DRAWINGS

To elucidate the various aspects presented in the exemplary embodiments of the present application, the accompanying drawings for describing exemplary embodiments will be briefly introduced below. It is apparent that the accompanying drawings described herein represent merely some embodiments of the present disclosure. A person of ordinary skill in the art may derive further, other drawings and variations based on the examples depicted in these drawings, without the need for further invention.

FIG. 1 is a schematic diagram illustrating a heat sink system according to some aspects of the disclosure.

FIG. 2 is a schematic diagram illustrating a heat sink control system according to some aspects of the disclosure.

FIG. 3 is a flow chart illustrating a heat sink control method according to some aspects of the disclosure.

FIG. 4 is a flow chart illustrating a method of calculating operating power based on the cold-end temperature of a heat sink in the heat sink control method according to some aspects of the disclosure.

FIG. 5 is a flow chart illustrating a method of using a first operating power threshold to constrain a calculated first operating power.

FIG. 6 is a flow chart illustrating a method of calculating operating power based on the hot-end temperature of the heat sink in the heat sink control method.

FIG. 7 is a flow chart illustrating a method of using the first operating power threshold to constrain the calculated first operating power and calculate a second operating power.

FIG. 8 is a flow chart illustrating a heat sink control method according to some aspects of the disclosure.

FIG. 9 is a flow chart illustrating a cooling fan control process in the heat sink control method according to some aspects of the disclosure.

FIG. 10 is a flow chart illustrating a processing of using different modes of a heat sink.

### DETAILED DESCRIPTION

In a heat sink device, a refrigeration chip can be used as the core component to dissipate heat from a target device. The refrigeration chip usually includes a cold end and a hot end. The cold end can be positioned close to the target device, such as a mobile phone or a camera, to cool the target device. The hot end is equipped with a heat sink for heat dissipation. Typically, during the heat dissipation process, an increase in power leads to a decrease in the temperature at the cold end of the refrigeration chip, while the temperature at the hot end of the refrigeration chip increases accordingly. Therefore, increasing the power of the refrigeration chip can rapidly decrease the temperature at its cold end. However, this introduces a problem: the higher the power used for high-efficiency cooling performed by the refrigeration chip, the higher the temperature of the heat sink at the hot end at the back of the refrigeration chip becomes. If the heat is not promptly dissipated, the hot end of the refrigeration chip struggles to dissipate heat due to excessively high temperature, significantly reducing the refrigeration efficiency of the refrigeration chip and posing a risk of burns to the user.

Aspects of the present disclosure provide a heat dissipation control method that enables a heat sink applying this control method to achieve both efficient cooling and maintain the temperature of the hot-end heat sink of the refrigeration chip within a safe range, thus preventing user burns.

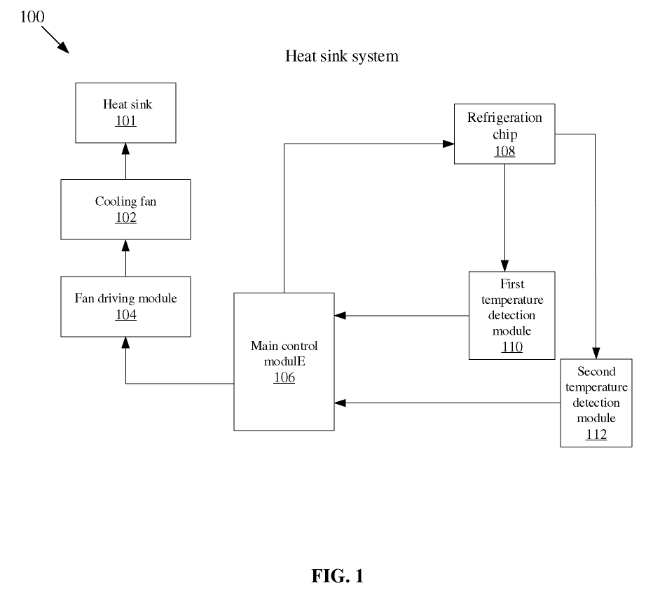

Aspects of the present disclosure provide a heat sink system, as shown in FIG. 1, including a main control MCU, temperature sensor A, temperature sensor B, a refrigeration chip, fan A, and fan B. The main control MCU, serving as the core control part of the heat sink system, can apply the heat dissipation control method described herein to control the operation of the heat sink system, including sensor data acquisition, refrigeration chip control, fan control, and, in some aspects, may also include Bluetooth communication, indicator light control, etc. In some examples, the heat sink system can connect to a user's mobile phone via Bluetooth communication, displaying the heat sink system's operating parameters on the user's phone interface. Indicator light control can involve using different colored indicator lights to indicate the operating status of the heat sink system, such as prompts for Bluetooth connection status, operating mode, or faults. Fans A and B are used to dissipate heat from the heat sink and can be controlled respectively by a fan A drive circuit and a fan B drive circuit connected to the main control MCU. The refrigeration chip, the core component of the heat sink, for example, can be a semiconductor refrigeration chip, and can be controlled by a refrigeration chip drive circuit connected to the main control MCU. Temperature sensor A (e.g., a first temperature detection module) is used to detect the temperature on the cold-end side of the refrigeration chip. For example, it can be, but is not limited to, the temperature of the silicone surface at the cold end of the refrigeration chip of the heat sink. The position of temperature sensor A can be adjusted as needed, provided it can detect the refrigeration temperature of the refrigeration chip. Temperature sensor B (e.g., a second temperature detection module) is used to detect the temperature on the hot-end side of the refrigeration chip of the heat sink. For example, it can detect the temperature of the heat sink at the hot end of the refrigeration chip. The position of temperature sensor B can be adjusted as needed, provided it can detect the heat dissipation temperature of the refrigeration chip.

Power can be supplied to the heat sink system through a power interface, for example a Type-C IN interface. In some aspects, a step-down circuit can be provided between the power interface circuit and the main control MCU module to reduce the voltage to an appropriate range, thereby supplying power to the main control MCU and downstream components.

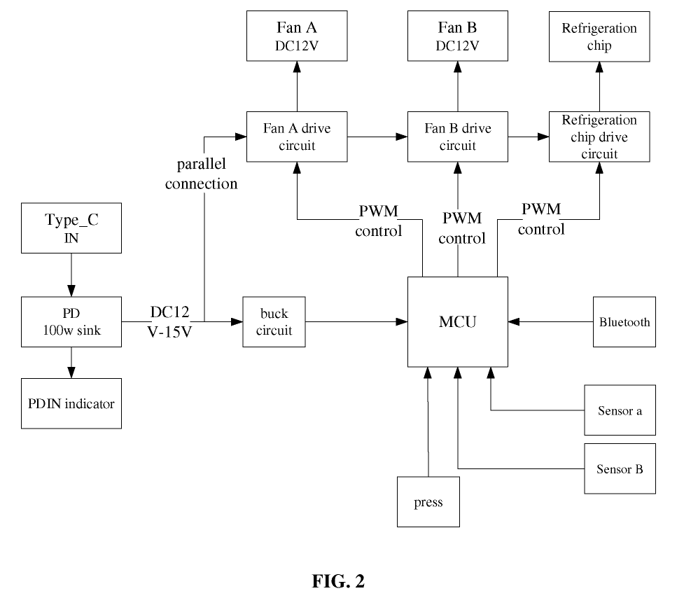

Referring to FIG. 2, aspect of the present disclosure provide a control method for a heat sink system, applied to the heat sink system described above. Through dual closed-loop control, the control method described herein enables the refrigeration temperature of the heat sink and the heat dissipation temperature of the heat sink to gradually reach a balance point. On one hand, the control method allows the side of the heat sink that cools the electronic device to rapidly reduce temperature, thereby enabling the electronic device to cool down quickly. On the other hand, under high-power conditions, it effectively controls the temperature at the hot-end heat sink of the refrigeration chip, reducing the impact of the hot end on the refrigeration performance of the refrigeration chip, thus ensuring that the heat sink described herein can rapidly cool the electronic device. Moreover, effectively controlling the hot-end temperature also effectively prevents the user getting burns from the heat sink. In some aspects, the control method is as follows:

S100: Calculating the operating power of the refrigeration chip through closed-loop control based on a predetermined first cold-end temperature threshold and the temperature at the cold end of the refrigeration chip.

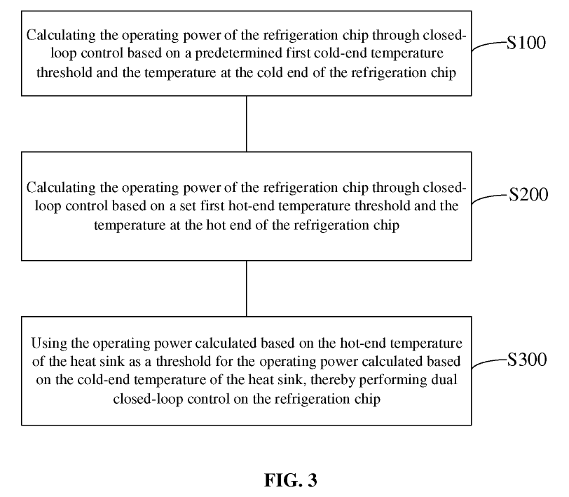

In this method, a target temperature is set, for example, a first cold-end temperature threshold. This first cold-end temperature threshold can be set based on requirements and further testing. In some examples, it could be the temperature required for rapid cooling of the device or the temperature set for a rapid water droplet icing test on the heat sink's silicone surface. In some aspects, the first cold-end temperature threshold herein can be -8° C to -13° C. Based on the temperature of the silicone surface of the refrigeration chip detected by temperature sensor A, the current refrigeration temperature can be obtained. Based on this refrigeration temperature and the set target temperature, the power of the refrigeration chip can be calculated through closed-loop control. In some examples, referring to FIG. 3, it includes:

S101: Performing a deviation comparison between the temperature detected by the first temperature sensor and a predetermined first cold-end temperature threshold, and calculating the operating power of the refrigeration chip through closed-loop control.

Closed-loop control is a technique that achieves automatic adjustment through feedback. The main control MCU module detects the current temperature in real-time via the first temperature sensor (temperature sensor A). The main control MCU module compares the actual temperature with the first cold-end temperature threshold, calculates the deviation, and calculates the operating power of the refrigeration chip based on a PID algorithm (proportional term (P) + integral term (I) + derivative term (D)) adjusted through multiple tests. Closed-loop control enables the temperature of the heat sink to be adjusted according to the preset values through continuous feedback correction. The PID algorithm is a classic closed-loop control strategy; its specific principles are not elaborated here.

The process of performing a deviation comparison between the temperature detected by the first temperature sensor and a preset first cold-end temperature threshold, and calculating the operating power of the refrigeration chip through closed-loop control, includes the following steps:

S102: Decreasing the operating power of the refrigeration chip if the temperature detected by the first temperature sensor is lower than or equal to the preset first cold-end temperature threshold.

This heat sink system employs closed-loop control for temperature regulation of the heat sink. In some examples, within this heat dissipation method, a first operating power threshold W1 is established, ranging from 20 watts (W) to 50W. Utilizing high power enables the refrigeration chip to effectively cool down to the preset temperature. During this process, a first cold-end temperature threshold is defined. When the temperature detected by temperature sensor A is lower than or equal to the preset first cold-end temperature threshold, it indicates that the real-time temperature of the refrigeration chip has already dropped below or approached the first cold-end temperature threshold, rendering the refrigeration temperature sufficiently low. In some examples, the main control MCU module can reduce the power of the refrigeration chip, calculating its operating power based on the PID algorithm, thereby slowing down the cooling rate of the refrigeration chip.

S103: Increasing the operating power of the refrigeration chip if the temperature detected by the first temperature sensor exceeds the preset first cold-end temperature threshold.

In closed-loop control, if the temperature detected by temperature sensor A is higher than the preset first cold-end temperature threshold, the main control MCU module can determine that the current real-time temperature of the refrigeration chip has not yet reached the first cold-end temperature threshold, and the heat sink has not effectively dissipated heat. Therefore, the main control MCU module can increase the power of the refrigeration chip, calculating its operating power based on the PID algorithm, to accelerate refrigeration and lower the refrigeration temperature of the refrigeration chip, thereby effectively dissipating heat from the electronic device.

S104: In some aspects, performing a deviation comparison between the calculated operating power and a first operating power threshold to determine a first operating power after calculating the operating power of the refrigeration chip through closed-loop control based on the set first cold-end temperature threshold and the temperature deviation at the cold end of the refrigeration chip.

As previously mentioned, in this control method, a first operating power threshold W1 is established. After calculating the operating power, considering potential errors, this heat sink system utilizes the first operating power threshold W1 to constrain the calculated first operating power. This process specifically includes:

S1041: Adopting the first operating power threshold W1 as the calculated first operating power if the operating power is greater than or equal to the first operating power threshold W1.

In some examples, taking the first operating power threshold W1 as 48W, if the main control MCU module calculates an operating power of 100W based on the PID algorithm, with the first operating power threshold W1 being 48W, then the operating power output by the main control MCU module is 48W. This arrangement prevents significant deviations in the calculated operating power, which is beneficial for protecting the refrigeration chip of the heat sink. On the other hand, the process can include:

S1042: Adopting the calculated first operating power if the operating power is less than the first operating power threshold W1.

In some examples, taking the first operating power threshold W1 as 48W, if the main control MCU module calculates an operating power of 20W based on the PID algorithm, with the first operating power threshold W1 being 48W, then the operating power output by the main control MCU module is 20W.

In summary, effective temperature control can be achieved through the cyclic process of monitoring, deviation comparison, and execution.

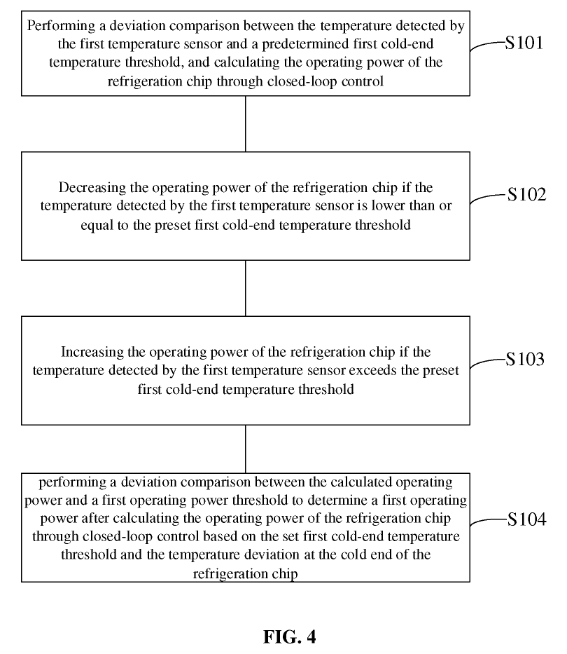

In some aspects, referring to FIGS. 2 and 4, concerning the heat sink at the hot end of the heat sink, the heat dissipation control method described herein also needs to consider the temperature of the heat sink to avoid excessively high temperatures that could burn the user. Accordingly, the control method for the heat sink described herein further includes:

S200: Calculating the operating power of the refrigeration chip through closed-loop control based on a set first hot-end temperature threshold and the temperature at the hot end of the refrigeration chip.

In this control method, a first hot-end temperature threshold can be established. In some examples, this temperature can be set based on testing to ensure a safe temperature that avoids burns to the user. In some aspects, this first hot-end temperature threshold can range from 55° C to 65° C. By detecting the temperature of the heat sink via a temperature sensor, the current real-time temperature of the heat sink can be obtained based on the safe temperature. Based on this heat sink temperature and the set safe temperature, the operating power of the refrigeration chip can be calculated through closed-loop control. In some aspects, referring to FIG. 4, this includes:

S201: Performing a deviation comparison between the temperature detected by the second temperature sensor and a preset first hot-end temperature threshold, and calculating the operating power of the refrigeration chip through closed-loop control.

In some aspects, the main control MCU can detect the current real-time temperature of the heat sink via the second temperature sensor (temperature sensor B). The main control MCU performs a deviation comparison between this real-time heat sink temperature and the preset first hot-end temperature threshold, and outputs an adjustment command based on a PID algorithm adjusted through multiple tests, calculating the operating power of the refrigeration chip, thereby effectively ensuring safety during the use of the heat sink. For example, the process can include the following steps:

S202: Decreasing the operating power of the refrigeration chip if the temperature detected by the second temperature sensor is higher than or equal to the preset first hot-end temperature threshold.

When controlling the heat sink's operation with high power, the temperature at the heat sink of the refrigeration chip is positively correlated with the power; i.e., the higher the power, the higher the temperature at the heat sink, which can easily burn the user. This heatsink system sets a first hot-end temperature threshold. If the temperature detected by the second temperature sensor (temperature sensor B) is higher than or equal to the preset first hot-end temperature threshold, the temperature at the heat sink risks burning the user. Therefore, at this point, based on closed-loop control, the main control MCU responds rapidly, reducing the power of the refrigeration chip, thereby causing the temperature at the heat sink to decrease accordingly, thus preventing burns to the user.

S203: Increasing the operating power of the refrigeration chip if the temperature detected by the second temperature sensor is lower than the preset first hot-end temperature threshold.

In the closed-loop control of the refrigeration chip, if the temperature detected by temperature sensor B is lower than the first hot-end temperature threshold, the temperature at the heat sink is relatively low at that moment. Therefore, the main control MCU can increase the power of the refrigeration chip according to the closed-loop control, thereby enabling the refrigeration chip to cool rapidly, which can improve refrigeration efficiency.

In some examples, monitoring via temperature sensor B enables the main control MCU to effectively monitor the temperature at the heat sink and respond promptly to feedback, thereby ensuring user safety.

In some aspects, as mentioned earlier, this heat sink system sets a first operating power threshold. In the PID loop at the hot end, the calculated first operating power threshold can also be used to constrain the operating power calculated based on the hot-end PID loop, specifically including:

S204: After calculating the operating power of the refrigeration chip through closed-loop control based on the set first hot-end temperature threshold and the temperature deviation at the hot end of the refrigeration chip, performing a deviation comparison between the calculated operating power and the first operating power threshold to determine a second operating power.

As mentioned earlier, in this control method, a first operating power threshold W1 is established. After calculating the operating power, considering potential errors, this application utilizes the first operating power threshold W1 to constrain the calculated first operating power, calculating a second operating power. For example, this process can include:

S2041: Adopting the first operating power threshold W1 as the calculated second operating power if the operating power is greater than or equal to the first operating power threshold W1.

In some examples, taking the first operating power threshold W1 as 48W, if the main control MCU module calculates an operating power of 100W based on the PID algorithm, with the first operating power threshold W1 being 48W, then the operating power output by the main control MCU module is 48W. This arrangement prevents significant deviations in the calculated operating power, which is beneficial for protecting the heat sink of the refrigeration chip. On the other hand, the process can include:

S2042: Adopting the first operating power as the calculated second operating power if the operating power is less than the first operating power threshold W1.

In some examples, taking the first operating power threshold W1 as 48W, if the main control MCU module calculates an operating power of 30W based on the PID algorithm, with the first operating power threshold W1 being 48W, then the operating power output by the main control MCU module is 30W.

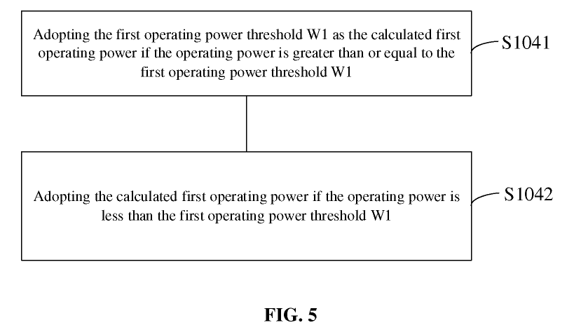

Referring to FIGS. 2 and 5, this heat sink system can perform precise data acquisition and algorithmic processing on the refrigeration temperature, heat sink temperature, and power, implementing dual closed-loop control on the refrigeration chip to achieve both efficient cooling and maintenance of the heat sink temperature within a safe range. In some aspects, the control method described herein further includes:

S300: Using the operating power calculated based on the hot-end temperature of the heat sink as a threshold for the operating power calculated based on the cold-end temperature of the heat sink, thereby performing dual closed-loop control on the refrigeration chip.

In some examples, the process of calculating power based on the cold-end temperature of the refrigeration chip is defined as the first closed loop, and the process of calculating power based on the hot-end temperature of the refrigeration chip is defined as the second closed loop. The operating power calculated based on the cold-end temperature of the heat sink is defined as value A, and the operating power calculated based on the heat sink temperature is defined as value B. As can be understood from the preceding text, the operating power calculated based on the first closed loop (first operating power) is value A, and the operating power calculated based on the second closed loop (second operating power) is value B. In some examples, value B is used as a threshold for the operating power calculated as value A, performing dual closed-loop control on the refrigeration chip. In some aspects, in the dual closed loop with the first closed loop and the second closed loop, the main control MCU module compares value A and value B, and outputs one of these values as the operating power for the refrigeration chip of the heat sink. In summary, by constraining value A with value B, this heat sink system ensures that the refrigeration chip can cool effectively while guaranteeing the safety of the heat sink. Referring to FIG. 5, which specifically includes:

S301: Using value B as the operating power for the refrigeration chip of the heat sink if value A is greater than or equal to value B.

After calculating value A based on the first closed loop and value B based on the second closed loop, the main control MCU module compares value A and value B. If value A is greater than or equal to value B, value B is used as the operating power for the refrigeration chip of the heat sink. The refrigeration chip in the heat sink system mentioned above operates at this operating power.

S302: Using value A as the operating power for the refrigeration chip of the heat sink if value A is less than value B.

In some examples, after calculating value A based on the first closed loop and value B based on the second closed loop, the main control MCU module compares value A and value B, and uses value A as the operating power for the refrigeration chip of the heat sink. The refrigeration chip in the heat sink system mentioned above operates at this operating power.

In some examples, by constraining value A with value B, the refrigeration chip can effectively cool while ensuring the safety of the heat sink. Particularly, when the heat sink temperature and the cold-end temperature of the refrigeration chip are respectively close to the first hot-end temperature threshold and the first cold-end temperature threshold, the power varies within a specific range. The cold end can attain the target temperature and effectively cool the electronic device near that target temperature, while the hot-end temperature is also constrained by the second closed loop. Furthermore, the operating power calculated based on the second closed loop can, in turn, constrain the operating power calculated based on the first closed loop, thereby preventing excessively high temperatures at the heat sink. In summary, this enables the hot end and cold end of the heat sink's refrigeration chip to reach a balanced state.

In some examples, regarding heat dissipation from the heat sink, a cooling fan can be installed on the heat sink to dissipate heat. After the heat sink is powered on, the fan can operate at full speed to dissipate heat from the heat sink.

In some examples, after the main control MCU module maintains the temperature at the cold end of the refrigeration chip at the preset first cold-end temperature threshold for N seconds, where n ranges from 25s to 30s, it switches the first cold-end temperature threshold of the refrigeration chip to a second cold-end temperature threshold, switches the first hot-end temperature threshold of the refrigeration chip to a second hot-end temperature threshold, and switches the first operating power threshold W1 to a second operating power threshold W2, where W2 ranges from 10W to 30W, performing dual closed-loop control on the refrigeration chip. In some aspects, based on the newly set parameters, such as the second cold-end temperature threshold, the second hot-end temperature threshold, and the second operating power threshold W2, the dual closed-loop control process by the main control MCU module is consistent with the preceding description. Here, the first cold-end temperature threshold ranges from -8° C to -13° C, and the second cold-end temperature threshold ranges from -3° C to -7° C; the first hot-end temperature threshold ranges from 55° C to 65° C, and the second hot-end temperature threshold ranges from 20° C to 45° C; n ranges from 25s to 35s, and W2 ranges from 10W to 30W. In some examples, under demonstration mode (super refrigeration without contacting the temperature-controlled electronic device, or refrigeration without contacting the temperature-controlled electronic device), the silicone surface of the heat sink can approach the first cold-end temperature threshold and the second hot-end temperature threshold, corresponding to the refrigeration chip operating at a high operating power. The main control MCU uses this high operating power to enable the heat sink to cool rapidly.

In usage mode (contacting the surface of the temperature-controlled electronic device, where the mode can be super refrigeration mode or refrigeration mode), it indicates that the heat sink is cooling towards the first cold-end temperature threshold and the second cold-end temperature threshold with high operating power. In actual use, the temperature of the heat sink's silicone surface and the electronic device's surface should account for the temperature after heat exchange between the cold-end temperature of the heat sink and the temperature of the electronic device.

With such an arrangement, at the first cold-end temperature threshold, the heat sink can rapidly cool the electronic device. After the temperature has been lowered, the temperature of the electronic device can be stabilized through the second cold-end temperature threshold. At this point, the power of the refrigeration chip can be switched to a lower power, and the corresponding temperature of the heat sink will decrease; therefore, the rotational speed of the cooling fan can be reduced. The present application does not limit the number of cooling fans; for example, there can be one or two cooling fans.

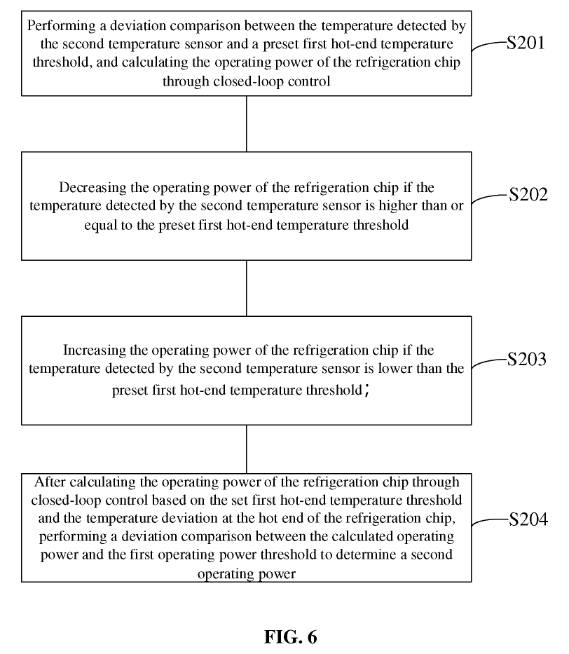

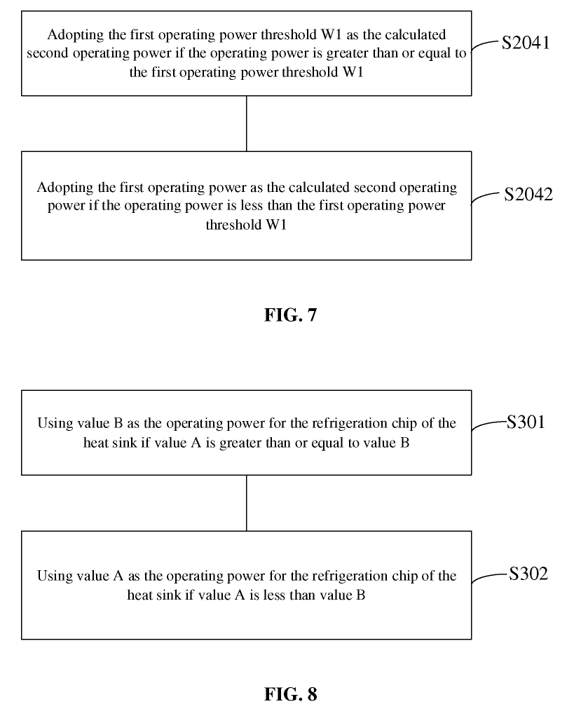

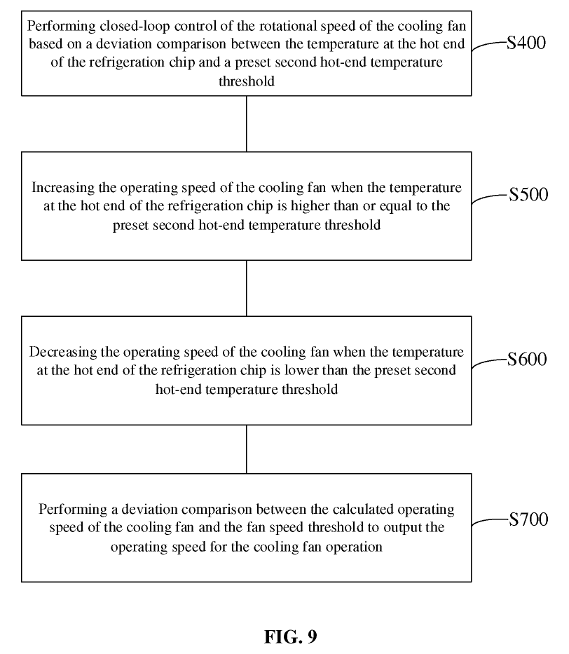

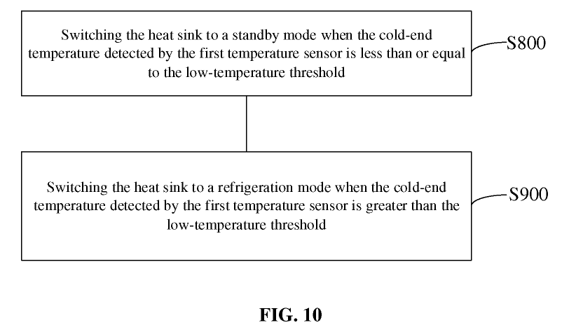

Referring to FIG. 6, aspects of the present disclosure further provide a method for controlling a cooling fan with a fan speed threshold. The testing standard for this fan speed threshold can be such that the noise generated by fan operation does not cause disturbance to the user; In some examples, the fan speed threshold is controlled at approximately 75% of full speed. The control method includes:

S400: Performing closed-loop control of the rotational speed of the cooling fan based on a deviation comparison between the temperature at the hot end of the refrigeration chip and a preset second hot-end temperature threshold.

In some aspects, a deviation comparison can be performed based on the second hot-end temperature threshold and the temperature detected at the hot end of the refrigeration chip. Taking the second hot-end temperature threshold as 45° C for example, the following process is carried out:

S500: Increasing the operating speed of the cooling fan when the temperature at the hot end of the refrigeration chip is higher than or equal to the preset second hot-end temperature threshold.

S600: Decreasing the operating speed of the cooling fan when the temperature at the hot end of the refrigeration chip is lower than the preset second hot-end temperature threshold.

S700: Performing a deviation comparison between the calculated operating speed of the cooling fan and the fan speed threshold to output the operating speed for the cooling fan operation. In some examples, this includes:

S701: Using the fan speed threshold as the operating speed for the heat sink fan operation when the operating speed of the cooling fan is greater than or equal to the fan speed threshold.

S702: Using the operating speed of the cooling fan as the operating speed for the heat sink fan operation when the operating speed of the cooling fan is less than the fan speed threshold.

In some aspects, when a user uses an electronic device, they turn on the heat sink system, which rapidly cools the electronic device. When the user stops using the device, there may be instances where they forget to turn off the heat sink system. If the heat sink system continues to cool the standby electronic device for an extended period, the temperature of the heat sink's silicone surface may become excessively low. Alternatively, the user may remove the heat sink system from the electronic device being cooled but forget to turn it off. This process can be considered a no-load condition for the heat sink. In the above scenarios, an excessively low temperature of the electronic device being cooled can lead to condensation, potentially causing damage to the device being cooled. Furthermore, prolonged no-load operation of the heat sink can reduce its lifespan and lead to condensation issues. Therefore, aspects of the present disclosure also provides a low-temperature and no-load detection function. The user can enable this mode; In some aspects, a preset low-temperature threshold is set, which can be determined based on testing.

S800: Switching the heat sink to a standby mode when the cold-end temperature detected by the first temperature sensor is less than or equal to the low-temperature threshold.

S900: Switching the heat sink to a refrigeration mode when the cold-end temperature detected by the first temperature sensor is greater than the low-temperature threshold.

With such an arrangement, when the user enables the low-temperature and no-load detection function, for example, by turning on a switch via a user interface (UI), and while the main control MCU module is controlling the refrigeration chip to operate at high power for rapid cooling, if temperature sensor A detects that the cold-end temperature is less than or equal to the low-temperature threshold, the main control MCU module controls the refrigeration chip to enter the standby mode. If temperature sensor A detects that the temperature is greater than the low-temperature threshold, it controls the heat sink to enter the refrigeration mode.

In summary, the user can, through the main control MCU module, determine whether the heat sink is experiencing a low-temperature or no-load condition and can promptly initiate corresponding protective mechanisms, shutting down the operating power of the refrigeration chip and entering standby mode. When the temperature becomes too high, the main control MCU module can re-initiate the operation of the refrigeration chip to rapidly cool the electronic device. For example, a low-temperature threshold can be set to detect an electronic device surface temperature of 13° C to 15° C.

The present application can also provide a computer-readable storage medium. The computer-readable storage medium stores a computer program. When the computer program is executed by a processor, the aforementioned heat dissipation control method is implemented.

All or part of the functions of the various methods in the above embodiments can be implemented by hardware or by computer programs. When all or part of the functions in the above embodiments are implemented by computer programs, the program can be stored in a computer-readable storage medium, which may include: read-only memory, random-access memory, magnetic disk, optical disk, hard disk, etc. The program is executed by a computer to implement the above functions. For example, the program is stored in the memory of a device, and when the processor executes the program in the memory, all or part of the above functions can be implemented. Additionally, when all or part of the functions in the above embodiments are implemented by computer programs, the program can also be stored in a storage medium such as a server, another computer, a magnetic disk, an optical disk, a flash drive, or a mobile hard disk, and can be saved to the memory of a local device by downloading or copying, or the system of the local device can be updated to a newer version. When the processor executes the program in the memory, all or part of the functions in the above embodiments can be implemented.

What is claimed is:

1. A control method for a heat sink, wherein the heat sink comprises a refrigeration chip, comprising:
calculating an operating power of the refrigeration chip through closed-loop control based on a set first cold-end temperature threshold and a temperature deviation at a cold end of the refrigeration chip;
calculating an operating power of the refrigeration chip through closed-loop control based on a set first hot-end temperature threshold and a temperature deviation at a hot end of the refrigeration chip; and
performing dual closed-loop control on the refrigeration chip by using the operating power calculated based on a temperature at the hot end of the heat sink as a threshold for the operating power calculated based on a temperature at the cold end of the heat sink.

2. The control method for a heat sink according to claim 1, wherein the heat sink further comprises a first temperature sensor for detecting a temperature at the cold end of the refrigeration chip; and
wherein calculating the operating power of the refrigeration chip through closed-loop control based on the first cold-end temperature threshold and the temperature deviation at the cold end of the refrigeration chip, comprises:
comparing the temperature detected by the first temperature sensor with a preset first cold-end temperature threshold for deviation, and calculating the operating power of the refrigeration chip through closed-loop control.

3. The control method for a heat sink according to claim 2, wherein comparing the temperature detected by the first temperature sensor with the preset first cold-end temperature threshold for deviation, and calculating the operating power of the refrigeration chip through closed-loop control, comprises:
reducing the operating power of the refrigeration chip in response to the temperature detected by the first temperature sensor being lower than or equal to the preset first cold-end temperature threshold; and
increasing the operating power of the refrigeration chip in response to the temperature detected by the first temperature sensor being higher than the preset first cold-end temperature threshold.

4. The control method for a heat sink according to claim 1, wherein the heat sink further comprises a second temperature sensor for detecting a temperature of a heat dissipation fin at the hot end of the heat sink; and
wherein calculating the operating power of the refrigeration chip through closed-loop control based on the set first hot-end temperature threshold and the temperature deviation at the hot end of the refrigeration chip, comprises:
comparing the temperature detected by the second temperature sensor with a preset first hot-end temperature threshold for deviation, and calculating the operating power of the refrigeration chip through closed-loop control.

5. The control method for a heat sink according to claim 4, wherein comparing the temperature detected by the second temperature sensor with the preset first hot-end temperature threshold for deviation, and calculating the operating power of the refrigeration chip through closed-loop control comprises:
reducing the operating power of the refrigeration chip in response to the temperature detected by the second temperature sensor being higher than or equal to the preset first hot-end temperature threshold; and
increasing the operating power of the refrigeration chip in response to the temperature detected by the second temperature sensor being lower than the preset first hot-end temperature threshold.

6. The control method for a heat sink according to claim 4, wherein the operating power calculated based on the temperature at the cold end of the heat sink is defined as a value A, and the operating power calculated based on the temperature of the heat dissipation fin is defined as a value B; and
wherein performing dual closed-loop control on the refrigeration chip by using the operating power calculated based on the temperature at the hot end of the heat sink as the threshold for the operating power calculated based on the temperature at the cold end of the heat sink, comprises:
using the value B as the operating power of the refrigeration chip of the heat sink in response to the value A being greater than or equal to the value B; and
using the value A as the operating power of the refrigeration chip of the heat sink in response to the value A being less than the value B.

7. The control method for a heat sink according to claim 6, further comprising:
setting a first operating power threshold W1;
after calculating the operating power of the refrigeration chip through closed-loop control based on the set first cold-end temperature threshold and the temperature deviation at the cold end of the refrigeration chip, performing a deviation comparison between the calculated operating power and the first operating power threshold to calculate a first operating power; and
after calculating the operating power of the refrigeration chip through closed-loop control based on the set first hot-end temperature threshold and the temperature deviation at the hot end of the refrigeration chip, performing a deviation comparison between the calculated operating power and the first operating power threshold to calculate a second operating power;
wherein the first operating power is configured as the value A, and the second operating power is configured as the value B; and
the first operating power threshold is in the range of 20 watts to 50 watts.

8. The control method for a heat sink according to claim 7, wherein the heat sink comprises a cooling fan disposed on the heat dissipation fin at the hot end of the refrigeration chip for dissipating heat from the heat dissipation fin, further comprising:
controlling the cooling fan based on the temperature of the refrigeration chip.

9. The control method for a heat sink according to claim 8, further comprising:
switching the first cold-end temperature threshold of the refrigeration chip to a second cold-end temperature threshold after maintaining the temperature at the cold end of the refrigeration chip at a preset first cold-end temperature threshold for N seconds;
switching the first hot-end temperature threshold of the refrigeration chip to a second hot-end temperature threshold;
switching the first operating power threshold W1 to a second operating power threshold W2; and
performing dual closed-loop control on the refrigeration chip;
wherein the first cold-end temperature threshold is in the range of -8° C to -13° C, and the second cold-end temperature threshold is in the range of -3° C to -7° C;
wherein the first hot-end temperature threshold is in the range of 55° C to 65° C, and the second hot-end temperature threshold is in the range of 20° C to 55° C; and
wherein N seconds is in the range of 25s to 35s, and W2 is in the range of 10w to 30w.

10. The control method for a heat sink according to claim 9, wherein a fan speed threshold is set, further comprising:
performing a deviation comparison based on the temperature at the hot end of the refrigeration chip and a preset second hot-end temperature threshold, and executing closed-loop control on a rotational speed of the cooling fan;
increasing the rotational speed of the cooling fan in response to the temperature at the hot end of the refrigeration chip being higher than or equal to the preset second hot-end temperature threshold;
reducing the rotational speed of the cooling fan in response to the temperature at the hot end of the refrigeration chip being lower than the preset second hot-end temperature threshold; and
performing a deviation comparison between the calculated rotational speed of the cooling fan and the fan speed threshold to output an operating rotational speed of the cooling fan.

11. The control method for a heat sink according to claim 2, further comprising:
comparing the temperature detected by the first temperature sensor with a preset low-temperature threshold;
controlling the heat sink to enter a standby mode in response to the temperature detected by the first temperature sensor being lower than or equal to the low-temperature threshold; and
controlling the heat sink to enter a cooling mode in response to the temperature detected by the first temperature sensor being higher than the low-temperature threshold.

12. A heat sink system, comprising:
a refrigeration chip configured for cooling;
a first temperature detection module configured to detect a temperature at a cold end of the refrigeration chip;
a second temperature detection module configured to detect a temperature at a hot end of the refrigeration chip;
a fan driving module configured to drive a cooling fan to operate; and
a main control module configured to perform, based on the temperature at the cold end of the refrigeration chip and the temperature at the hot end of the refrigeration chip,
wherein the head sink system is operated according to the control method of claim 1.
